(19) United States
(12) Patent Application Publication
(10) Pub. No.: US 2026/0273579 A1
(43) Pub. Date: Sep. 17, 2026

(54) Intelligent Labeling and Automatic Sorting Apparatus

(71) Applicant: Tao Wei, ROWLAND HEIGHTS, CA (US)

(72) Inventor: Tao Wei, ROWLAND HEIGHTS, CA (US)

(21) Appl. No.: 19/171,271

(22) Filed: Apr. 6, 2025

(30) Foreign Application Priority Data
Mar. 11, 2025 (CN) 202510281942X

(51) Int. Cl. B07C 3/02; G01S 17/08; G06F 3/12; G06K 7/14

(52) U.S. Cl. CPC B07C 3/02; G01S 17/08; G06F 3/12; G06K 7/1404

(57) ABSTRACT

An intelligent labeling and automatic sorting apparatus is disclosed, comprising a conveyor, sensors, barcode scanners, a labeling module, a printing module, a control system, and a sorting mechanism. The apparatus detects parcel size, orientation, and position using light curtains and vision sensors, enabling accurate label placement. The first vision sensor verifies the label and identifies the courier company to direct parcels to the correct chute. Labeling anomalies are automatically sorted into a designated area for review. The system supports real-time adjustment of labeling and sorting parameters via a human-machine interface, ensuring operational flexibility in warehousing and logistics environments.

### FIELD OF THE INVENTION

The present invention relates to the field of logistics automation equipment, and more particularly to an intelligent labeling machine for warehouse shipping applications. The invention is capable of automatically adapting to packages of various sizes and shapes, enabling efficient, accurate labeling and automatic sorting.

### BACKGROUND OF THE INVENTION

Conventional labeling machines currently available on the market are generally suitable only for packages of fixed dimensions. When a package varies in height or width, the operator must manually adjust the height and lateral position of the labeling machine, increasing operational complexity and time costs.

Additionally, existing machines typically require manual barcode scanning for each package, as well as precise manual placement of the package in a fixed position on the conveyor system to ensure labeling accuracy. This not only reduces overall labeling efficiency but also increases dependence on manual labor.

Furthermore, most existing devices are limited to labeling packages with smooth surfaces. When the surface of a package is uneven or irregular, labeling may fail, negatively affecting the accuracy and stability of logistics operations.

Therefore, there is a strong need in the market for an intelligent labeling apparatus capable of automatically detecting package dimensions, orientation, and position, and of adapting to uneven surfaces to perform efficient and accurate labeling.

### SUMMARY OF THE INVENTION

The primary objective of the present invention is to provide an intelligent labeling apparatus capable of automatically detecting the size, position, and orientation of a package, adjusting the labeling position in real time, and enabling efficient and precise labeling. The system is further designed to adapt to irregular surfaces and incorporates visual recognition and automatic sorting functions to improve overall operational efficiency and reduce manual intervention.

The intelligent labeling apparatus of the present invention comprises the following components and technical solutions:

### Automatic Adaptation to Package Size

The system utilizes X-axis (214) and Z-axis (225, 226) servo-controlled linear modules, allowing precise adjustment based on the height and lateral position of the package, thereby achieving fully automated labeling without manual adjustment.

Package height and position are detected by photoelectric curtain sensors (308, 309) and distance sensors (117, 318, 319). The distance sensors (318, 319) are primarily used to detect the lateral position of the package on the conveyor (300) and transmit the data to the control system (302). Combined with measurement data from a secondary vision sensor (311), this improves the accuracy of package position detection and enhances both labeling and sorting precision.

A rotation mechanism (208, 209) allows the labeling module to label packages at various angles, accommodating different package orientations.

### Intelligent Visual Recognition and Automatic Scanning

The scanning system includes a first barcode scanner (310) mounted on the conveyor (300) and a second scanner (103) mounted on a support plate (100) that moves vertically with the Z-axis (225, 226). These scanners read barcodes or QR codes on the packages and transmit the data to the control system (302) or an external information management system. The external system may include, but is not limited to, a warehouse management system (WMS), enterprise resource planning system (ERP), order management system (OMS), or other logistics information platforms.

Based on the scanned information, the control system (302) or external system generates a print command and sends it to a printing module (111), which prints the corresponding label.

If the first scanner fails to read the code, the second scanner (103) automatically performs a supplementary scan to ensure successful identification and improve labeling accuracy.

### Visual Verification and Sorting Control

A first vision sensor (106) is used to inspect the printed label and compare it with preset data to ensure labeling accuracy.

Additionally, the first vision sensor (106) identifies the carrier (e.g., shipping company) based on the printed shipping label and instructs the control system (302) to adjust the sorting mechanism (400), which directs the package to the corresponding chute (401, 402, 403) for sorting. In the event of labeling errors or missed labels, the system diverts the package to an exception handling area for manual inspection or re-labeling, thus maintaining the reliability of logistics operations.

The first vision sensor (106) also scans barcodes on labeled packages and uploads the data to the WMS or other logistics information systems to complete inventory dispatch and ensure real-time synchronization of logistics information.

### Orientation and Height Detection

A second vision sensor (311) is used to detect the orientation, lateral position, and height of the package, providing data for precise label positioning.

### Adaptation to Irregular Surfaces

Unlike traditional labelers limited to flat surfaces, the present invention incorporates a pressing mechanism (116) in conjunction with a distance sensor (117) to dynamically adjust the pressing angle during labeling. This ensures successful label application even on packages with uneven surfaces.

A pressing motor (115) controls the angle and pressure of the pressing mechanism, allowing for real-time fine adjustments to prevent peeling or poor adhesion caused by surface irregularities.

### Automated Sorting for Improved Efficiency

After labeling, the first vision sensor (106) verifies the label content. Based on comparison results, the system determines the sorting path for each package.

A paddle wheel sorter (400) then automatically adjusts its angle under control system commands to guide packages into the appropriate chutes (401, 402, 403), achieving fully automated sorting with no manual intervention and significantly improving workflow efficiency.

### Conveyor Pause Logic

The conveyor system consists of two segments. If the photoelectric curtain sensors (308, 309) and the second vision sensor (311) detect that the height or position of the next package significantly differs from the current one, the first segment of the conveyor will pause operation to prevent labeling errors.

The conveyor resumes operation only after the current package is labeled and the labeling mechanism is adjusted for the next package's height and position.

### BRIEF DESCRIPTION OF THE DRAWINGS

FIG. 1 is a schematic view of the overall structure of the intelligent labeling and sorting apparatus adaptable to package size, according to the present invention.

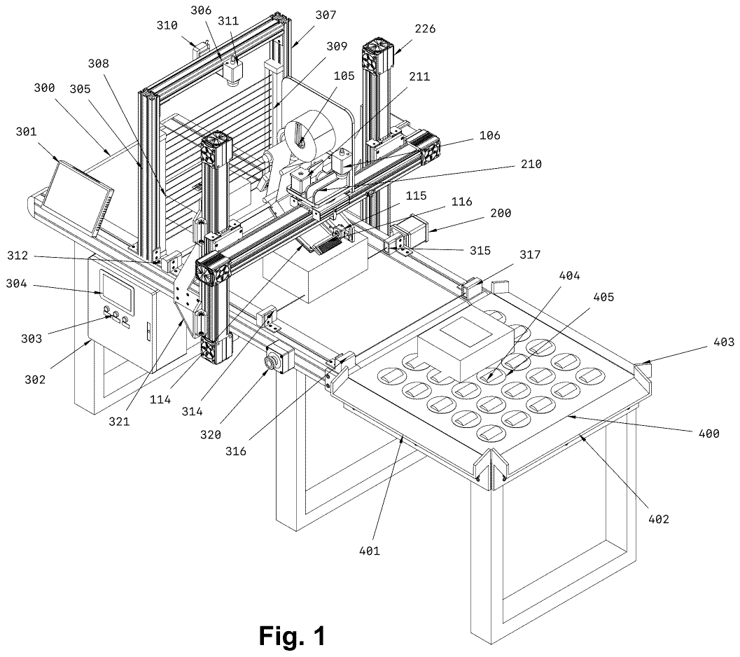

FIG. 2 is another perspective view of the intelligent labeling and sorting apparatus.

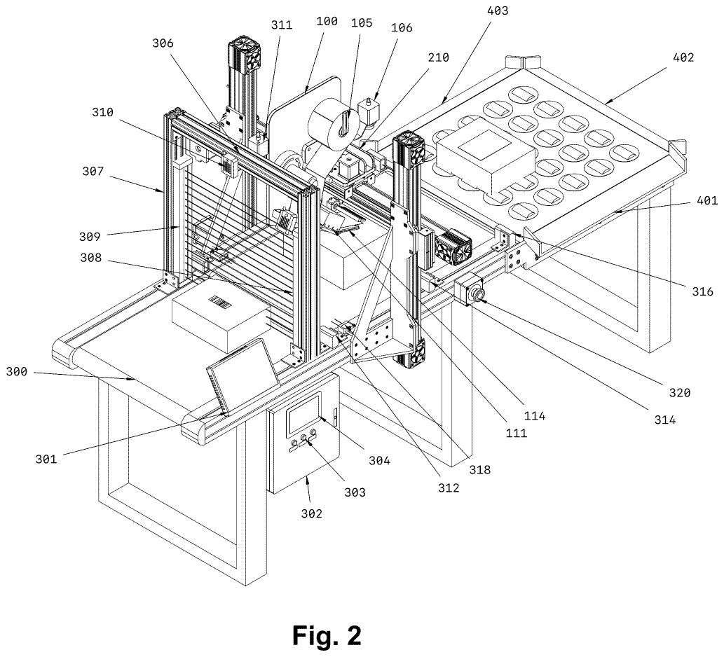

FIG. 3 is a side view of the intelligent labeling and sorting apparatus.

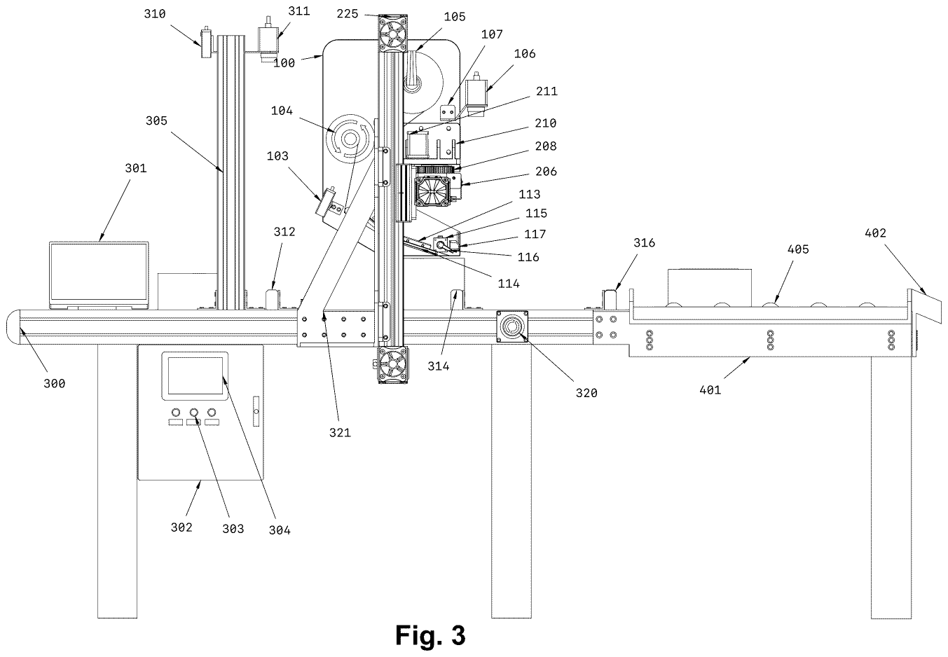

FIG. 4 is a top view of the intelligent labeling and sorting apparatus.

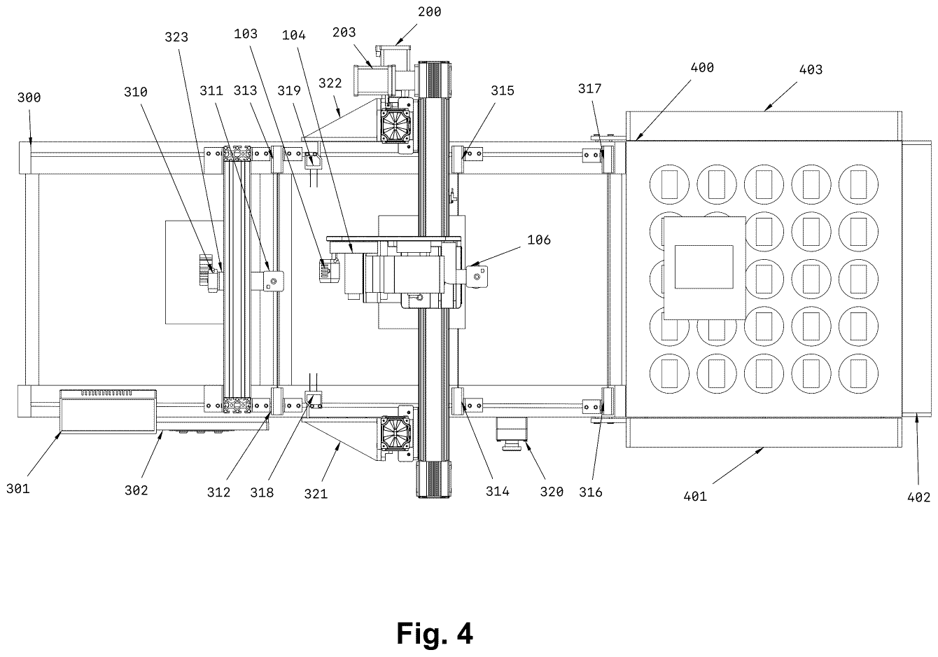

FIG. 5 is a schematic view of the labeling mechanism.

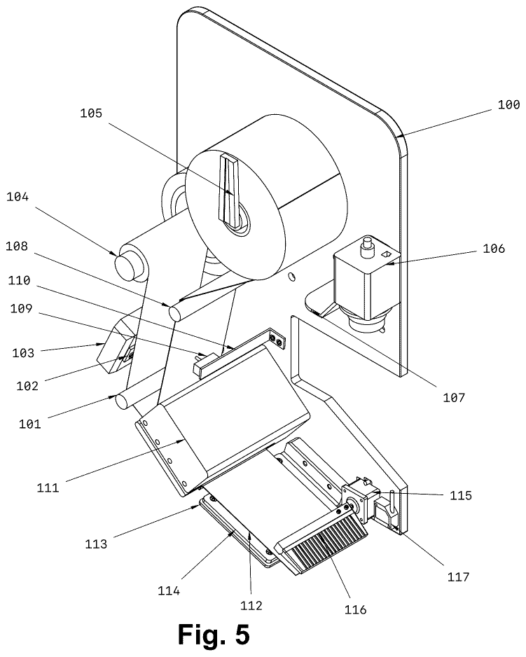

FIG. 6 is another perspective view of the labeling mechanism.

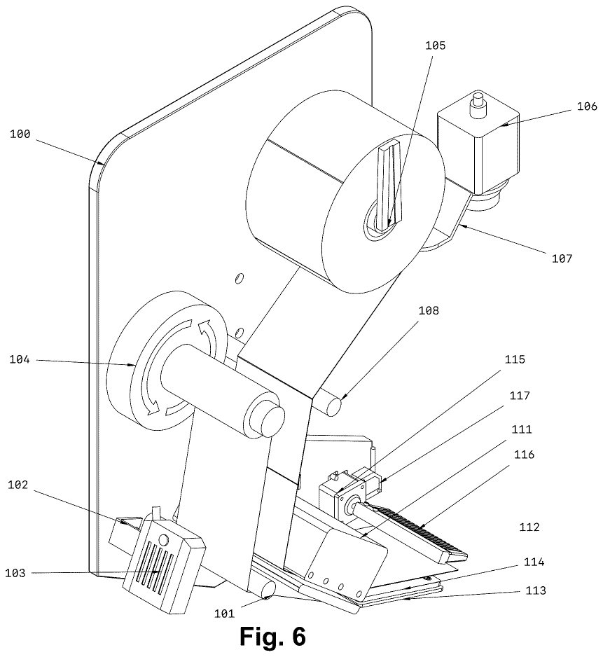

FIG. 7 is a side view of the labeling mechanism.

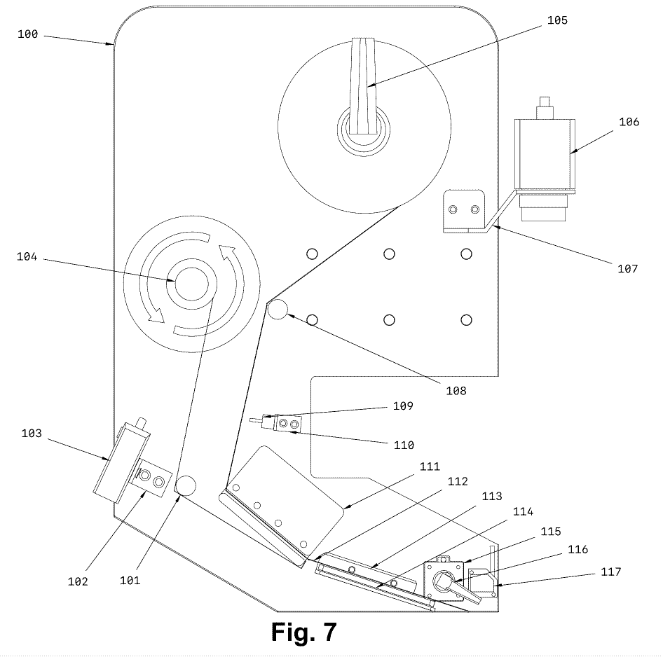

FIG. 8 is a schematic view of the label application subassembly within the labeling mechanism.

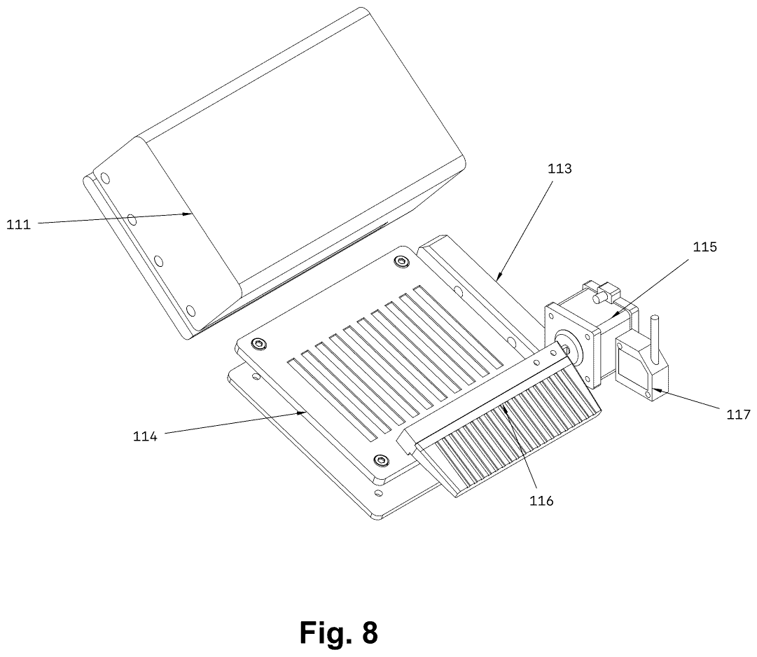

FIG. 9 is a schematic view of the liner rewinding assembly within the labeling mechanism.

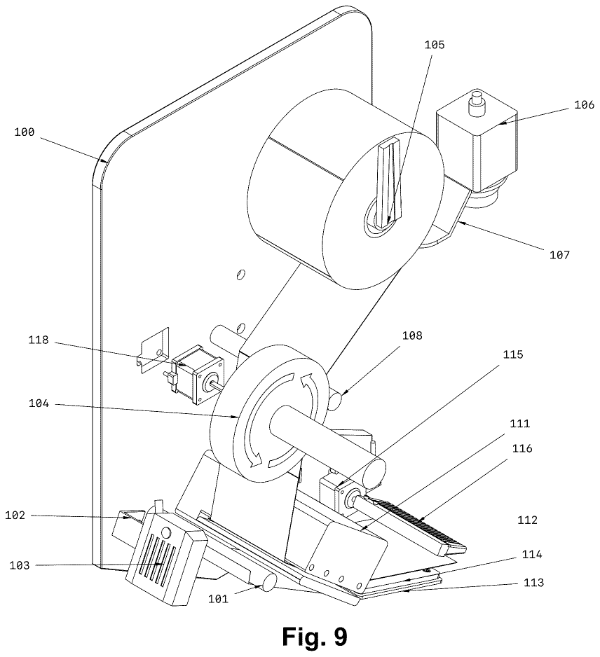

FIG. 10 is a bottom view of the labeling mechanism.

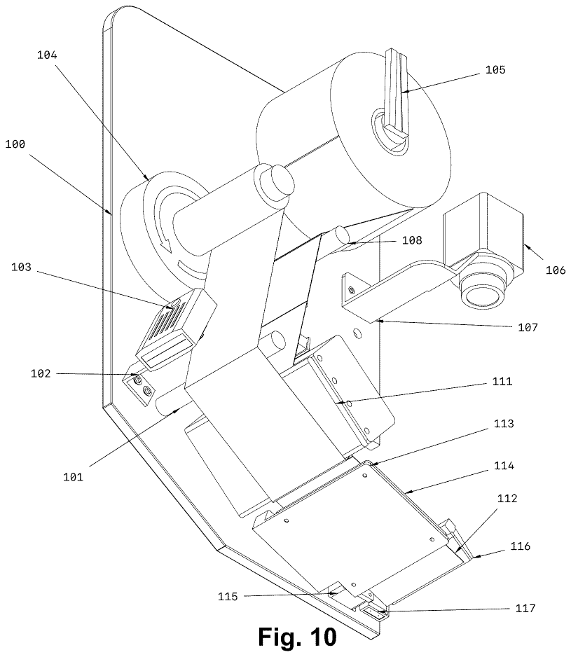

FIG. 11 is a structural schematic view of the Z-axis and X-axis motion mechanism of the labeling machine.

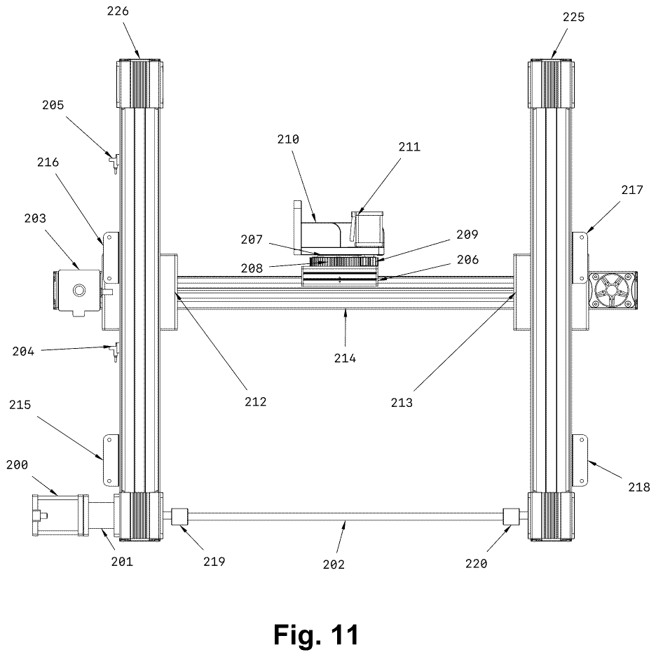

FIG. 12 is a 3D perspective view of the Z-axis and X-axis motion mechanism of the labeling machine.

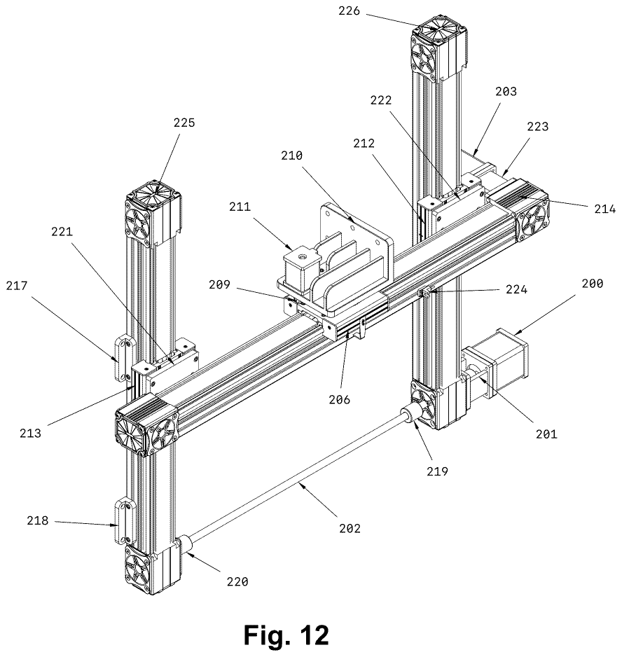

FIG. 13 is a schematic view of the X-axis sliding platform and rotary mechanism.

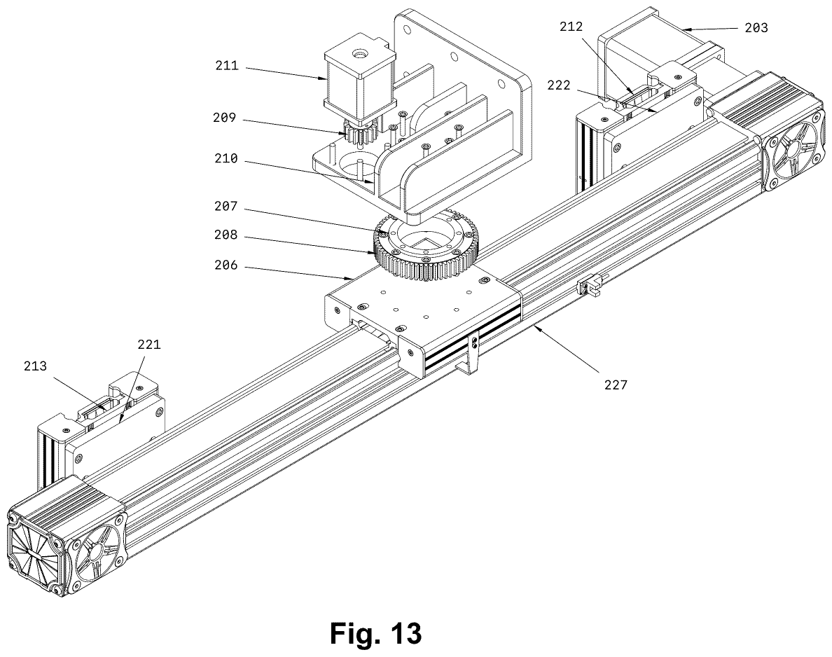

FIG. 14 is a schematic view of the conveyor unit and sorting mechanism of the intelligent labeling and sorting apparatus.

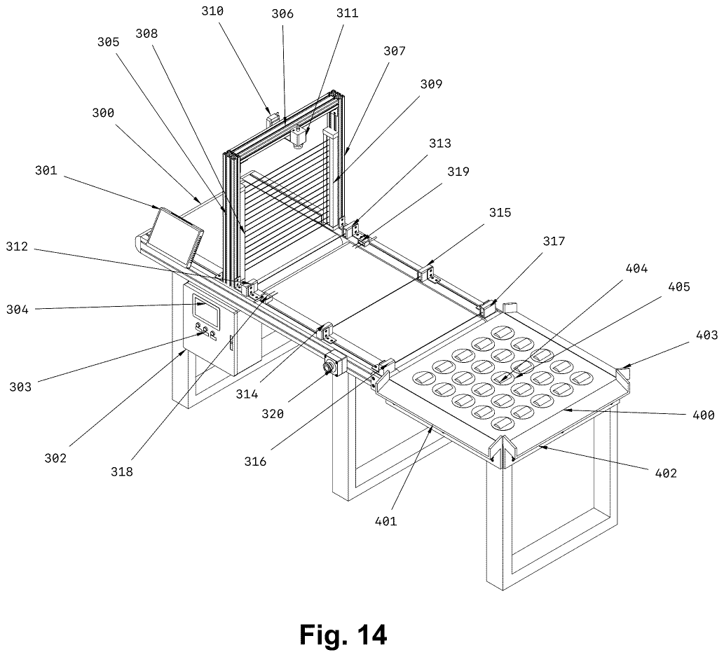

FIG. 15 is a top view of the conveyor unit and sorting mechanism.

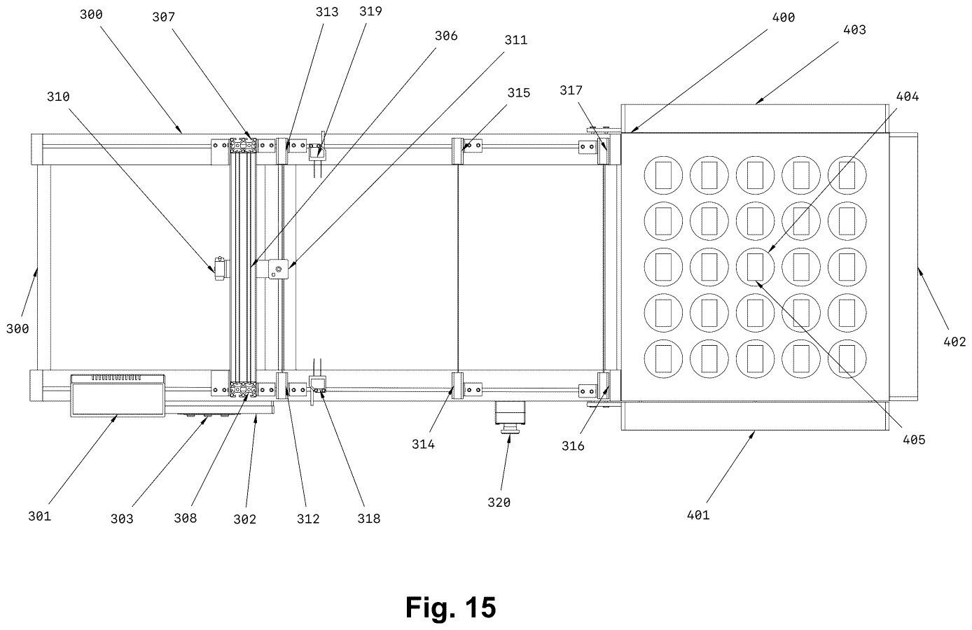

### IN THE DRAWINGS

100: Mounting plate for second scanner, first vision sensor, and printer
101: First label guiding rod
102: Mounting bracket for second scanner
103: Second scanner
104: Automatic liner rewinder
105: Label roll holder
106: First vision sensor
107: Mounting bracket for first vision sensor
108: Second label guiding rod
109: Label shortage detection sensor
110: Mounting bracket for label shortage sensor
111: Label printer
112: Printed label
113: Mounting bracket for anti-stick plate
114: Label anti-stick plate
115: Pressing mechanism motor
116: Pressing mechanism
117: First distance sensor
118: Rewinder motor
200: First servo motor
201: Mounting bracket for first servo motor
202: Z-axis synchronous shaft
203: Second servo motor
204: First limit sensor
205: Second limit sensor
206: X-axis slider
207: Inner ring of rotary mechanism
208: Driven gear of rotary mechanism
209: Driving gear of rotary mechanism
210: Connection plate
211: Third servo motor
212: Second slider
213: First slider
214: X-axis linear module
215-218: Z-axis angle code brackets A-D
219: Coupling for first Z-axis synchronous shaft
220: Coupling for second Z-axis synchronous shaft
221-222: First and second connecting plates
223: Mounting bracket for second servo motor
224: Third limit sensor
225-226: First and second Z-axis linear modules
300: Conveyor unit
301: Computer
302: Control system
303: Control buttons
304: Programmable HMI
305-307: Columns and beams of scanner/vision mounting frame
308-309: Photoelectric curtain emitter and receiver
310: First barcode scanner
311: Second vision sensor
312-317: Photoelectric sensor pairs 1-3 (transmitters and receivers)
318-319: Second and third distance sensors
320: Emergency stop switch
321-322: Mounting brackets for Z-axis modules
323: Mounting bracket for first scanner and second vision sensor
400: Paddle wheel sorting machine
401-403: First to third chutes
404: Sorting rotation mechanism
405: Sorting rollers

### DETAILED DESCRIPTION OF THE INVENTION

When the labeling apparatus is activated, it performs automatic calibration and returns to the zero position. The motion modules, including the X-axis (214), Z-axes (225, 226), and rotary mechanisms (208, 209), are reset to their initial positions. Simultaneously, the conveyor system (300) and the paddle wheel sorting mechanism (400) begin operating.

As a package enters the first segment of the conveyor, the first photoelectric sensor (312, 313) detects its arrival and triggers the height detection system—such as the photoelectric curtain sensors (308, 309) or other distance measuring devices—and the second vision sensor (311) to begin data acquisition.

The photoelectric curtain sensors (308, 309), installed on opposite sides of the conveyor (300), serve as the primary height detection mechanism. As the package passes through the curtains, its height is precisely measured and the data is sent to the control system (302), which adjusts the vertical position of the mounting plate (100) and the labeling mechanism (116) accordingly.

The second vision sensor (311), mounted above the conveyor (300), primarily detects the angle and lateral position of the package and also serves as a supplementary height sensor. If the curtain sensors (308, 309) fail or yield low-accuracy results, height data from the vision sensor (311) may be used to ensure reliable and accurate measurements, thereby improving the accuracy of the label positioning system.

The second vision sensor (311) collects angle, lateral position, and height data of the package. The second and third distance sensors (318, 319) assist in lateral positioning to ensure the package is precisely located on the conveyor (300).

The first barcode scanner (310) scans the barcode on the package and transmits the result to the control system (302) or an external information management system. Based on the scanned information, the control system (302) or external system generates a print command and sends it to the printer module (111), which prints the corresponding label.

If the first scanner fails, the second scanner (103) is automatically activated to perform a supplementary scan.

A label anti-stick plate (114) is positioned below the printer (111) output slot to receive the printed label.

The control system (302) calculates the optimal labeling position and adjusts the X-axis (214), Z-axes (225, 226), and rotary mechanisms (208, 209), ensuring the labeling mechanism (116) is properly aligned with the target area on the package.

The pressing mechanism (116) is then activated. Based on real-time feedback from the first distance sensor (117), the system adjusts the pressing angle to ensure firm label adhesion, even on uneven surfaces.

When the package reaches the paddle wheel sorter (400), the control system (302) adjusts the rotation angle of the sorting mechanism (404) based on labeling results, directing the package into the correct chute (401, 402, 403) and completing the automatic labeling and sorting process.

It should be noted that the number of sorters (400) and corresponding chutes (401, 402, 403) shown in the drawings is illustrative only. In practical applications, the number of sorters and chutes may be increased or decreased based on logistics requirements, and the mapping between sorters and chutes can be flexibly configured. The invention is not limited to any specific number of sorting units.

The linear modules mentioned in the present invention may include, but are not limited to, screw-driven modules, timing-belt modules, rack-and-pinion modules, linear motor modules, electromagnetic drive modules, pneumatic modules, or hydraulic modules, in single or combined forms. The invention is not limited to any specific type.

The sorter (400) may adopt various mechanical forms depending on application scenarios, including paddle wheel, pusher, pneumatic swing arm, slider, cross-belt, flipper, rotary disc, or other configurations. The invention does not limit the structural form of the sorter.

The conveyor system (300) may employ belt, roller, cross-belt, chain plate, pallet, air cushion, or other conveying methods. It can be adapted according to package size, weight, shape, and delivery requirements.

The conveyor system (300), working in conjunction with the curtain sensors (308, 309) and second vision sensor (311), can dynamically adjust speed and direction to ensure optimal positioning during labeling and sorting. It may further integrate with the control system (302) to flexibly alter the path and enable accurate and efficient logistics handling.

Additionally, the conveyor system (300) may include adjustment mechanisms such as variable-speed motors, tiltable tracks, or telescopic rollers to accommodate different package specifications and improve the applicability of the labeling and sorting process.

The rotary mechanism (208, 209) may utilize slewing bearings, servo motor drives, pneumatic swing cylinders, rack-and-pinion drives, electromagnetic clutches, worm gear drives, swing rails, or other mechanical, pneumatic, or electromagnetic devices capable of rotating the mounting plate (100), depending on the orientation of the package.

The intelligent labeling and sorting apparatus of the present invention can be integrated with various information management systems, including but not limited to Warehouse Management Systems (WMS), Enterprise Resource Planning (ERP) systems, Order Management Systems (OMS), and other logistics platforms. After barcode or QR code scanning, the control system (302) may process the data directly or forward it to the external system for interpretation, which then determines logistics information and issues commands to the printer module (111) accordingly.

This architecture allows the system to meet the needs of diverse warehouse and logistics environments. It is applicable not only to e-commerce fulfillment centers, express logistics, and smart distribution hubs, but also to product identification and tracking on manufacturing lines, thereby enhancing data accuracy and automation.

The directional indicators and structural connections shown in the drawings are illustrative and are not intended to limit the actual physical orientation or connectivity of components in use.

Although servo motors are used in the embodiments described herein, it is understood that other types of motors, including but not limited to stepper motors, pneumatic actuators, hydraulic drives, or other drive mechanisms, may be used to achieve similar functionality, and such alternatives are considered within the scope of the present invention.

1. An intelligent labeling and automatic sorting apparatus, comprising:
A conveying device (300) for transporting parcels to be labeled, wherein the conveying device includes but is not limited to belt conveyors, roller conveyors, cross-belt conveyors, chain conveyors, pallet conveyors, air cushion conveyors, and other transportation methods, and is capable of automatically adjusting the conveying speed and direction based on the parcel size, weight, and transportation requirements to match the labeling and sorting operations;
A height detection device, comprising at least one or a combination of vision sensors, laser rangefinders, or ultrasonic sensors, configured to measure the height of parcels;
Measurement light curtains (308, 309) disposed on both sides of the conveying device (300) for detecting the height information of the parcels and transmitting the height information to the control system (302) in real-time;
A second vision sensor (311), disposed above the conveying device (300), for detecting the angle, lateral position, and height of the parcel on the conveying device (300); and serving as an auxiliary height detection device. When the measurement light curtains (308, 309) fail to obtain accurate height data or require verification, the control system (302) verifies and corrects the height data using the measurements from the second vision sensor (311);
Second distance sensors (318, 319), installed on both sides of the conveying device (300), configured to detect the lateral position of the parcels and transmit the data to the control system (302) in real-time, improving the accuracy of parcel position measurement when combined with the second vision sensor (311);
A first vision sensor (106), installed on the mounting plate (100), configured to detect the content of the attached label and compare it with preset data to identify the courier company associated with the shipping label and control the sorting machine (400) accordingly;
A scanning device, comprising a first barcode scanner (310) disposed on the conveying device (300) and a second barcode scanner (103) mounted on the mounting plate (100) and capable of moving along the Z-axis (225, 226), for scanning the barcode or QR code on the parcel and transmitting the scanning results to the control system (302) or an external information management system, which generates and sends a printing instruction to the printing module (111) to print the corresponding label;
A printing module (111), installed on the mounting plate (100), for printing labels based on scanning information from the scanning device;
A rewinder motor (118), operating synchronously with the printing module (111) to recover label backing paper in real-time during printing;
A label anti-stick plate (114), located below the label outlet of the printing module (111) for holding labels;
A pressing mechanism (116), installed on the mounting plate (100), for affixing printed labels to the parcels;
A first distance sensor (117), configured to detect height variations on the parcel surface in real-time;
X-axis (214) and Z-axis (225, 226) lifting and movement devices, configured to adjust the position of the mounting plate (100) so that the pressing mechanism (116), second barcode scanner (103), first vision sensor (106), and printing module (111) mounted on the mounting plate (100) move synchronously to adapt to parcels of different sizes and positions;
A rotating mechanism (208, 209), configured to drive the entire mounting plate (100) to rotate, thereby adjusting the angle of the second barcode scanner (103), first vision sensor (106), and printing module (111) to accommodate parcels placed in different orientations;
The rotating mechanism (208, 209) includes but is not limited to slewing bearings, servo motor drives, pneumatic swing cylinders, or rack-and-pinion transmission mechanisms to achieve the angular adjustment of the mounting plate (100);
A wheel sorting machine (400), with the number of sorting machines adjustable according to actual requirements, each of which sorts parcels into corresponding chutes (401, 402, 403) based on the detection results from the first vision sensor (106);
A control system (302), configured to receive information from various sensors and coordinate the operation of the above mechanisms;
A programmable human-machine interface (304), configured to adjust labeling modes, set labeling parameters (including label position, labeling speed, and labeling type), and configure sorting rules (including mapping different sorting chutes to specific courier companies or destinations), thereby enhancing system flexibility and adaptability.

2. The intelligent labeling and automatic sorting apparatus of claim 1, wherein the conveying device (300) comprises a first and second segment, and if the measurement light curtains (308, 309) and the second vision sensor (311) detect that the height or position of the next parcel differs significantly from the previous parcel, the first segment of the conveying device pauses operation until labeling is completed and adjustments for the new parcel are made.

3. The intelligent labeling and automatic sorting apparatus of claim 1, wherein the pressing mechanism (116) cooperates with the first distance sensor (117) to detect variations in the parcel surface height during labeling and adjusts the angle of the pressing mechanism motor (115) to accommodate uneven parcel surfaces.

4. The intelligent labeling and automatic sorting apparatus of claim 1, wherein the second vision sensor (311) is mounted on a frame (305, 306, 307) and provides parcel position information to allow the control system (302) to adjust the mounting plate (100) position so that the pressing mechanism (116), second barcode scanner (103), first vision sensor (106), and printing module (111) move synchronously to match different parcel sizes and positions.

5. The intelligent labeling and automatic sorting apparatus of claim 1, wherein the rotating mechanism (208, 209) is driven by a third servo motor (211) to adjust the angle of the mounting plate (100).

6. The intelligent labeling and automatic sorting apparatus of claim 1, wherein the pressing mechanism (116) is provided with a label anti-stick plate (114) to prevent premature adhesion of labels and ensure smooth label attachment to the parcel surface.

7. The intelligent labeling and automatic sorting apparatus of claim 1, wherein the control system (302) receives data from the second vision sensor (311) and the measurement light curtains (308, 309), calculates the optimal labeling position, and adjusts the X-axis (214) and Z-axis (225, 226) to ensure precise alignment of the pressing mechanism (116) with the parcel surface.

8. The intelligent labeling and automatic sorting apparatus of claim 1, wherein the second distance sensors (318, 319) measure the lateral position of the parcels and, in combination with the second vision sensor (311), correct the parcel's actual position on the conveying device (300).

9. The intelligent labeling and automatic sorting apparatus of claim 1, wherein the wheel sorting machine (400) receives instructions from the control system (302) and adjusts the angle of the sorting machine rotating mechanism (404) according to the label content detected by the first vision sensor (106), ensuring that parcels enter the correct chute (401, 402, 403).

10. The intelligent labeling and automatic sorting apparatus of claim 1, wherein the first vision sensor (106) detects labeling anomalies or missed labels and automatically sorts such parcels into a designated chute via the sorting machine (400) for manual inspection or re-labeling.

11. The intelligent labeling and automatic sorting apparatus of claim 1, wherein the programmable human-machine interface (304) enables operators to adjust sorting rules dynamically, configure labeling parameters, and modify parcel sorting logic based on operational requirements.

12. The intelligent labeling and automatic sorting apparatus of claim 1, wherein the first vision sensor (106) scans the barcode on labeled parcels and transmits the scanning information to the warehouse management system (WMS), logistics management system, or other information management systems to complete system-based outbound processing and ensure real-time synchronization of logistics data.

13. The intelligent labeling and automatic sorting apparatus of claim 1, wherein the X-axis (214) and Z-axis (225, 226) lifting and movement devices are driven by one or a combination of the following: ball screw linear modules, timing belt linear modules, rack and pinion linear modules, linear motor modules, electromagnetic drive modules, pneumatic modules, or hydraulic modules.

14. The intelligent labeling and automatic sorting apparatus of claim 1, wherein the wheel sorting machine (400) comprises one or a combination of the following sorting mechanisms: wheel-type sorting machine, push-rod sorting machine, pneumatic lever sorting machine, sliding block sorting machine, cross-belt sorting machine, flap sorting machine, or turntable sorting machine.

15. The intelligent labeling and automatic sorting apparatus of claim 1, wherein the number of wheel sorting machines (400) can be increased or decreased based on operational needs, and the corresponding number of chutes (401, 402, 403) can be adjusted accordingly.

16. The intelligent labeling and automatic sorting apparatus of claim 1, wherein the conveying device (300) includes but is not limited to belt conveyors, roller conveyors, cross-belt conveyors, chain conveyors, pallet conveyors, or air cushion conveyors.

17. The intelligent labeling and automatic sorting apparatus of claim 1, wherein the conveying device (300) cooperates with the measurement light curtains (308, 309) and the second vision sensor (311) to dynamically adjust the operational parameters of the conveying device (300) based on the detected parcel size and position information, ensuring that the parcel remains in the optimal position during the labeling and sorting process.

18. The intelligent labeling and automatic sorting apparatus of claim 1, wherein the conveying device (300) includes an adjustable mechanism such as a variable-speed motorized conveyor belt, tilt-adjustable transport track, or telescopic roller conveyor, enabling adaptation to different parcel sizes and enhancing labeling and sorting flexibility.

19. The intelligent labeling and automatic sorting apparatus of claim 1, wherein the first vision sensor (106) detects labeling anomalies or missed labels and sorts such parcels into a designated chute via the sorting machine (400) for manual inspection or re-labeling.

20. The intelligent labeling and automatic sorting apparatus of claim 1, wherein the first vision sensor (106) scans the barcode on labeled parcels and transmits the scanning information to a warehouse management system (WMS), logistics management system, or other information management systems to complete system-based outbound processing and ensure real-time synchronization of logistics data.
